(19) United States
(12) Patent Application Publication
(10) Pub. No.: US 2014/0072802 A1
(43) Pub. Date: Mar. 13, 2014

(54) POLYESTER POWDER COATINGS

(71) Applicant: Eduard A. Stefanescu, Butte, MT (US)

(72) Inventor: Eduard A. Stefanescu, Butte, MT (US)

(21) Appl. No.: 13/857,516

(22) Filed: Apr. 5, 2013

Related U.S. Application Data
(60) Provisional application No. 61/686,524, filed on Apr. 6, 2012.
(60) Provisional application No. 61/687,253, filed on Apr. 19, 2012.

(51) Int. Cl. C09D 5/03

(52) U.S. Cl. CPC C09D 5/03
USPC 428/402; 524/604; 524/444; 427/447; 427/459; 427/485

(57) ABSTRACT

Powder coating compositions are comprised of particles having a diameter of from about 20 μm to about 250 μm comprising: (1) a hydroxyl- and/or carboxyl-terminated polyester having a number average molecular weight of from about 1000 to about 6000 and a dynamic shear viscosity of less than 5000 cPs; (2) from about 1% to about 50% by weight of the polyester of a cross-linking agent capable of reacting with the terminal groups of the polyester and wherein the powder coating composition has a density of from about 0.95 g/cm³ to about 1.8 g/cm³. These compositions cure rapidly and provide coatings having superior physical-mechanical properties. The powder coating compositions can be applied by various methods but are particularly useful for thermal spray application methods.

### CROSS-REFERENCE TO RELATED APPLICATIONS

This application claims the benefit of provisional application Ser. No. 61/686,524, filed on Apr. 6, 2012, and provisional application Ser. No. 61/687,253, filed on Apr. 19, 2012. The entire contents of both applications are incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms, as provided for by the terms of Contract No. W911 QX-08-C-0049 awarded by the Department of Defense, United States Army.

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Various types of coatings have been used to protect a variety of metallic and non-metallic substrates and to improve surface properties of the substrate, such as finish, gloss, adhesion, water-impermeability, reflectivity, corrosion resistance, wear resistance, scratch resistance etc. Although wide varieties of coating methods exist and have been historically employed to coat such substrates, thermoset powder compositions have been shown to be particularly useful because of their substantially reduced hazardous volatile organic compounds (VOCs), coupled with superior physical properties and durability. The low VOC is a particularly critical requirement when such powder coating materials are applied in-situ by a technician using polymer thermal spray (PTS) systems, such as the propane-based 30 kW PTS and an electric 5 kW PTS systems developed by Resodyn Corporation.

Flame spray (3,000° C. combustion gas) and plasma arc (10,000° C. plasma gas) thermal spray technologies have been used to apply polymer coatings, but with limited success because surfaces coated through such methods contained burned and charred particles of the base polymer. The PTS technique and equipment allows for the rapid application of dry powder polymers onto high profile surfaces to create highly adherent, conformal film coatings. The PTS is a system that forms a sprayable polymer film using powdered precursor materials and in-process heating that does not degrade the polymer material. Some of the advantages of using the PTS technology over flame spray, electrostatic or other conventional methods include limited cure time needed through forced convection hot air, no special storage or handling requirements, no thickness limitations, no arcing to grounded substrates, no flame degradation of the coating, indefinite working pot life, spot to wide area coverage capability and in-situ repair capabilities. The PTS method is described in published U.S. patent application publication numbers 2012/0321811 and 2010/0009093, the entire contents of both of which are incorporated herein by reference.

Although thermoplastic materials have been designed for powder coatings and marketed for such applications, today the vast majority of commercial powder coating formulations are based on thermoset (or thermosetting) polymers. Thermoset polymers are materials that irreversibly cure through a chemical reaction which can occur at room temperature or high temperature, and can also be initiated by radiation. Typical powder coating thermoset polymers include, without limitation, polyesters, epoxies, polyester-epoxy hybrids, polyester-urethane hybrids, polyurethanes, acrylics etc. Having reactive chemical groups, these materials are expected to interact well with metallic and non-metallic substrates, resulting in good adhesion. Given their reactive nature, thermoset resins are incompatible with flame spray techniques because when such methods are employed, the cross-linking reaction is triggered before the fine polymeric granules reach the substrate and flow to form a continuous film. On the other hand, thermoset resins are particularly suited for use with the PTS method because the sprayed particulate material is never subjected to thermally degrading temperatures and because the sprayed material never comes in direct contact with the flame itself.

In the design of powder coating formulations for oven cure, certain aspects, such as economical factors and time-temperature dependent chemistries, play a critical role in establishing the resin-to-cross-linker ratios. When polymeric resins are heated above their melting temperature, the macromolecular chains gain extensive mobility. If allowed enough time, their functional groups can react with the functional groups of the cross-linker. The vice-versa mechanism also occurs since the cross-linker also possesses increased mobility and reacts with the functional groups on the polymeric macromolecules. In this chain of events, the limiting step in determining the rate of the reaction is typically the time needed for molecules to reach the optimum neighboring configuration that enables the reaction to proceed. The reaction itself occurs much faster. Because typical powder coatings are allowed to bake 10 to 15 minutes in ovens, at temperatures well above the melting temperature, the overall reaction can generate extensive cross-linking even when economical amounts of cross-linker are utilized. On the other hand, powder coating formulations designed for thermal spray applications do not have the luxury of being heated for 10 to 15 minutes, because that would make the process much too slow to be economically viable. In such applications, the coating is heated at the optimum temperatures for time frames of less than one minute. This particular aspect calls for cross-linker amounts in powder coating formulations higher than just the typical minimum economical amount, in order to increase the statistical probability of reactive groups finding each other and reaching the proper configuration in the short time frame. Therefore, resin-to-cross-linker ratios must be optimized in order to obtain useful powder coating formulations for polymer thermal spray applications. Furthermore, such optimizations should be performed with all other constituents present in the system (e.g., fillers, pigments, flow and degassing additives, anti-corrosive agents, etc.) in order to account for possible unforeseen side interactions (e.g., hydrogen bonding Van der Waals interactions, ionic and dipole-dipole interactions. etc.) that could interfere with the overall rate of the cross-linking reaction. One efficient tool in determining the reaction rate and temperature as a function of resin-to-cross-linker ratios is differential scanning calorimetry (DSC). One such example of using DSC to determine the optimum resin-to-cross-linker ratio is described in this disclosure.

### BRIEF SUMMARY OF THE INVENTION

The present invention pertains to polyester-based powder coating compositions having improved cure rate and superior physical-mechanical properties. They are particularly useful for thermal spray application methods and form transparent or opaque, non-yellowing, polyester thermoset powder coatings on metallic and non-metallic substrates.

The powder coating compositions according to the invention are comprised of particles having a diameter of from about 20 μM to about 250 μM comprising: (1) a hydroxyl- and/or carboxyl-terminated polyester having a number average molecular weight of from about 1000 to about 6000 and a dynamic shear viscosity of less than 5000 cPs; (2) from about 1% to about 50% by weight of the polyester of a cross-linking agent capable of reacting with the terminal groups of the polyester, and wherein the powder coating composition has a density of from about 0.95 g/cm³ to about 1.8 g/cm³.

The present invention also pertains to a method of spot repairing an existing coating on a substrate by thermal spray application of the polyester-based powder coating compositions according to the invention without subsequent curing. This method comprises the steps of: (1) heating a gas flow stream in a thermal spray gun to a temperature between about 100° C. to about 900° C. to produce a heated gas flow stream and projecting the heated gas flow stream toward a target damaged substrate coating through a point of convergence of a converging nozzle; injecting a powdered coating composition according to the invention into the heated gas flow stream through at least one material injector coupled to the thermal spray gun that is operative to propel the powdered material into the heated gas flow stream such that the powdered material at least partially melts within the heated gas flow stream to produce a plurality of heated material particles; and directing and propelling the heated material particles onto the damaged substrate coating surface whereby the damaged coating and the melted powder coating fuse together to produce a continuous coating.

### BRIEF DESCRIPTION OF THE FIGURES

Not Applicable

### DETAILED DESCRIPTION OF THE INVENTION

The powder coating compositions according to the invention are comprised of hydroxyl- and/or carboxyl-terminated thermosetting polyester having a number average molecular weight of from about 1000 to about 6000 and a dynamic shear viscosity of less than 5000 cPs. These polyesters can be made by any of the well-known synthetic methods for making polyesters such as by direct esterification of diacids and diols, or transesterification of diesters. The acid component may be any saturated aliphatic dicarboxylic acid such as, without limitation, adipic, azelaic or sebacic acid or mixtures thereof, and/or any aromatic dicarboxylic acid such as, for example, terephthalic and isophthalic acid or their derivatives, e.g., terephthaloyl chloride, isophthaloyl chloride, and the mono- and dialkyl esters of terephthalic and isophthalic acid. Additionally, the thermosetting polyester can be based on copolymers of which the acid constituent is a combination of terephthalic and/or isophthalic acid and/or saturated aliphatic dicarboxylic acid. The diol component can be a glycol selected, without limitation, from ethylene glycol, 1,4-butanediol, neopentyl glycol, or 1,4-cyclohexanedimethanol and 1,6-hexanediol and combinations thereof. Thermosetting polyesters can be, without limitation, carboxyl-functional or hydroxyl functional.

It is well known in the art that a variety of cross-linking agents can be utilized to cure carboxyl-terminated polyester resins. Preferably, such cross-linking agents include trisglycidylisocyanurate (TGIC); a β-hydroxyl alkylamide (HAA) compound such as bis-N,N-dihydroxyethyladipamide, sold commercially as PRIMID® XL-552, a trademark product of EMS Chemie AG; a hydroxyglycidyl ester and an isocyanate-containing compound, such as a polyisocyanate. The hydroxyglycidyl ester can be chosen from the group including, without limitation, hydroxypivalic acid, the glycidyl ester of 2-hydroxy-propionic acid, the glycidyl ester of hydroxybutyric acid or the glycidyl ester of 4-hydroxymethylbenzoic acid. The polyisocyanate can be chosen from the group including, without limitation, 1,6-hexane diisocyanate, 1,5-hexane diisocyanate, 1,5-naphthalene diisocyanate, 4,4′-diphenylmethane diisocyanate, 4,4′-diphenyldimethylmethane diisocyanate, di- and tetraalkyldiphenylmethane diisocyanate, 4,4′-dibenzyl diisocyanate, 1,3-phenylene diisocyanate, 1,4-phenylene diisocyanate, isomers of toluene diisocyanate, 1-methyl-2,4-diisocyanate cyclohexane, 1,6-diisocyanate-2,2,4-trimethyl hexane, 1,6-diisocyanate-2,4,4-trimethyl hexane and 1-isocyanatemethyl-3-isocyanatetrimethyl-1,5,5-cyclohexane (isophorone diisocyanate).

It is also well known in the art that a variety of cross-linking agents can be utilized to cure hydroxyl-terminated polyester resins. Such cross-linking agents preferably include blocked isocyanate such as, for example, including but not limited to, ε-caprolactam, aminoazole such as pyrrole, imidazole, 1,2,3- and 1,2,4-triazole, benzindazole and benzimidazole derivatives, pyrazoles such as 3,5-dimethylpyrazole, 3-methylpyrazole, 4-nitro-3,5-dimethylpyrazole and 4-bromo-3,5-dimethylpyrazole, etc. The cross-linking agent used in conjunction with the hydroxyl-functional polyesters can also be a non-blocked isocyanate such as an uretdione, and more specifically a polyuretdione.

The powder coating compositions according to the invention can be made by compounding the polyester and cross-linking components by such conventional methods which include, but are not limited to, dry mixing followed by melt mixing of components. The dry mixing can be performed employing, without limitation, conventional blenders, overhead mixers, vibratory mixers, ultrasound mixers, acoustic mixers, etc. The melt blending can be performed employing, without limitation, twin screw extruders, kneader extruders, Banbury mixers, etc. The grinding of thermoset formulations can be performed at ambient temperatures employing, without limitation, conventional granulators, hammer mills, attrition mills, roll mills, centrifugal mills, etc. Example 1 below sets forth a more detailed method of preparation of powder coating compositions according to the invention.

The powder coating compositions according to the invention can be applied to a substrate by such methods which include, but are not limited to, electrostatic fluidized bed, fluidized bed, hot flocking, electrostatic spray, and tribocharging processes, followed by curing in an oven at the reaction temperature, or thermal spray (PTS) methods that do not require post-heating the coating in an oven.

The powder coating compositions according to the invention afford exceptionally durable, aesthetically pleasing, corrosion- and wear-protective coatings when employed on metallic substrates such as steel, aluminum, copper, phosphor-bronze alloys, copper-nickel-tin alloys, copper-nickel-zinc alloys, copper-nickel alloys, etc. and non-metallic structures such as above- and below-grade concrete structures, brick, concrete masonry unit (CMU) block, grout, plaster, gunite, tile, aggregate, etc. The powder coating compositions according to the invention, although suitable for conventional electrostatic applications, are very suitable for thermal spraying (PTS) applications, ensuring low melt viscosities coupled with fast curing rates. Therefore, the disclosed thermoset coating formulations are field deployable and do not require an oven to induce the curing reaction, allowing for a broad range of flexibility in coating structures that would otherwise not be suitable for coating with durable powder coating formulations; such structures suitable for field powder coating may include, without limitation, bridges, or sections of bridges, buildings or sections of buildings, airplanes, ships, industrial equipment such as machinery, hangars, pipes, water slides, fences, rails, light and traffic-light pools, roller-coaster structures or sections, roofs, concrete and plaster pools, fiberglass pools, etc. The powder coating compositions according to the invention exhibit superior physical-mechanical characteristics such as adhesion, flexibility, toughness and hardness and can be designed with different finishes and gloss.

The powder coating compositions according to the invention are also especially useful for immediate spot repair of damaged coatings because they exhibit excellent adhesion to existent paints and powder coatings of a wide variety of chemistries, including without limitation epoxies, polyesters, epoxy-polyester hybrids, polyester-urethane hybrids, polyurethanes, acrylics, etc. Spot repair is necessary when an existing coating is damaged by, for example, scratching, cracking or flaking, or debonded as a result of various mechanical actions. Additionally, coatings exhibiting yellowing or color and gloss loss as a result of excessive weathering can be easily recoated with the powder coating compositions according to the invention without the need of removing the existent coating. The spot repair of a target substrate which is a substrate having a damaged coating can be carried out by a method comprising the steps of: (1) heating a gas flow stream in a thermal spray gun to a temperature between about 100° C. to about 900° C. to produce a heated gas flow stream and projecting the heated gas flow stream toward a damaged substrate coating through a point of convergence of a converging nozzle; (2) injecting the powder coating compositions according to the invention into the heated gas flow stream through at least one material injector coupled to the thermal spray gun that is operative to propel the powdered material into the heated gas flow stream at angles that are substantially normal to the heated gas flow stream such that the powdered material at least partially melts within the heated gas flow stream to produce a plurality of heated material particles; and (3) directing and propelling the heated material particles onto the damaged substrate coating whereby the damaged coating and the melted powder coating fuse together to produce a continuous coating. This method is described in published U.S. patent application publication numbers 2012/0321811 and 20100009093, the entire contents of both of which are incorporated herein by reference.

The following Examples are meant to illustrate but not to limit the invention.

### Example I

A very important step in designing thermoset formulations, particularly for polymer thermal spray (PTS) applications, is the optimization of the resin-to-cross-linker ratio. In this example a carboxyl terminated resin (Uralac® 3220) was obtained from DSM, and a β-hydroxylalkylamide (HAA) cross-linker (Primid® XL-552) was obtained from EMS-Griltech. The resin manufacturer offers a variety of resins for HAA cross-linking at cross-linker values of 5-7 weight % based on the weight of the resins. When employing the Uralac® 3220 resin, the manufacturer recommends that the finished powder coating material should be cured in an oven at 180° C. for six minutes.

A rigorous optimization of the cross-linker level was undertaken in order to achieve the highest curing rate in the finished product. To that end, powder coating materials with various resin-to-cross-linker ratios were fabricated and subjected to differential scanning calorimetry (DSC) measurements. The DSC results show that the material comprising 8.6 weight % cross-linker based on the weight of the resin was found to provide the lowest cure temperature.

Other optimizations performed included choosing the nature of the ceramic fillers and the loading of ceramic filler to obtain the best performance coating. For example, the nature of the employed ceramic filler in thermoset formulations was determined to be instrumental in achieving the best ultraviolet resistance behavior. This is depicted in Table 1. From the information in Table 1, it is apparent that the alumino-silicate ceramic spheres (W-210 from 3M) alone do not impart good UV resistance to the formulations. On the other hand, the presence of only 4.4 weight % TiO₂ (Ti-Pure® R-350 from DuPont) improved significantly the UV resistance of the thermoset formulations. A thermoset formulation containing only Ti-Pure® R-350 as filler (loadings of 20-30 weight %) would have an even better UV resistance behavior; however, the cost of W-210 is almost 70% lower than the cost of Ti-Pure® R-350.

TABLE 1
Effect of filler's nature on the UV behavior

| | | Ti-Pure ® R- | | |
|---|---|---|---|---|
| | W210 | 350 | | 60° gloss loss |
| | Microspheres | TiO2 filler | Total filler | (%) after 1000 h |
| | Weight % | Weight % | Weight % | UV exposure |
| 1. | 16.4% | 0 | 16.4% | 97.8 |
| 2. | 15.5% | 4.4% | 19.9% | 15.6 |

Furthermore, the filler loading had to be optimized to obtain the hardest coating possible, without detrimentally affecting coating adhesion, flexibility and toughness. A pencil hardness of at least 2H was targeted. It is important to note that while the density of Ti-Pure® R-350 is about 4.2 g/cm³, the density of W-210 is about 2.4 g/cm³, which means that for a similar weight loading, the volume loading of W-210 in the formulation is almost double than that of Ti-Pure® R-350. Several variations of the filler loadings and their effect on the coating's hardness are presented in Table 2. In two of the cases, the hardness of the coating was observed to be dependent on coating thickness. More precisely, while thicker coatings yielded a pencil hardness of H, thinner coatings of the same material yielded a pencil hardness of 2H. The optimization continued until a coating was obtained that consistently yielded a pencil hardness of 2H for thicknesses between 75 μm and 150 μm.

TABLE 2
Effect of filler loading on the UV behavior

| | W-210 | Ti-Pure ® | Total | |
|---|---|---|---|---|
| | Microspheres | R-350 | filler | Pencil |
| | Weight % | Weight % | Weight % | hardness |
| 1. | 15.5% | 4.4% | 19.9% | H |
| 2. | 14.8% | 8.5% | 23.3% | H-2H |
| 3. | 17.3% | 4.3% | 21.6% | H-2H |
| 4. | 19.0% | 4.2% | 23.2% | 2H |

Based on the cross-linker and filler ratio optimization described above, a thermoset powder coating composition was prepared in accordance with Formulation A presented below. Component percentages by weight of the formulation are given.

Formulation A

| Component (Product | | Purpose in |
|---|---|---|
| Name) | Weight % | Formulation |
| Uralac ® 3220 | 63.61% | Thermoset resin |
| Primid ® XL-552 | 5.51% | Cross-linker |
| Resiflow PL200 | 1.27% | Flow aid |
| W-210 | 19.08% | Ceramic filler |
| Ti-Pure ® R-350 | 4.24% | Filler/pigment |
| Halox ® 710 | 5.09% | Corrosion Inhibitor |
| Oxymelt ® A4 | 1.06% | Bubble release |
| Regal ® 660R | 0.13% | Carbon black |
| | | Pigment |
| TOTAL | 100.00% | |

All components of Formulation A were dry mixed together in a capped plastic container through the means of Resodyn Corporation's LabRAM® (ResonantAcoustic® technology). Next, the dry mixture was fed into a twin screw extruder that was operated at 300 revolutions per minute (rpm) to generate a torque of between 50 percent and 95 percent of the extruder's torque capability. The extruder's entrance and exit zone temperatures were adjusted to be 90° C. and 120° C., respectively. Following extrusion, the formulation was finely ground, through the means of a centrifugal grinder, and sieved through mesh number 140 to generate material particles with an average diameter of less than or equal to 104 micrometers (μm).

The coating formulation was applied on 154 mm long, 76 mm wide and 0.8 mm thick steel panels by a thermal spray (PTS) technique at a temperature of 180° C. to a thickness between 75 μm and 150 μm for a total period of less than one minute. The coatings and the substrates were allowed to cool to room temperature (20° C.). No subsequent post-heating was employed.

When the thermoset coating of Formulation A was subjected to a chemical rub test involving 100 double rubs with a mixture of 90 weight % mineral spirits and 10 weight % methyl ethyl ketone (MEK), in accordance with the military specification MIL-PRF-24712, the coating exhibited no material loss, indicating sufficient cross-linking and excellent resistance to the chemical mixture.

When the thermoset coating of Formulation A was subjected to pull-off adhesion testing, in accordance with ASTM D4541, it yielded values between 5 and 8 mega-pascals (MPa), indicating excellent adhesion to steel. Similar values were obtained on aluminum and bronze.

When the thermoset coating of Formulation A was subjected to a mandrel bend flexibility test, in accordance with ASTM D522, the coating exhibited no cracking, indicating excellent flexibility.

Furthermore, when the thermoset coating of Formulation A was subjected to 185 kilogram-centimeters (kg-cm) direct impact testing, in accordance with ASTM D5420, the coating exhibited no flaking or debonding, indicating excellent toughness. Similarly, no flaking or debonding was detected when the thermoset coating of Formulation A was subjected to 185 kilogram-centimeters (kg-cm) reverse impact testing, in accordance with ASTM D5420.

In addition, when the thermoset coating of Formulation A was subjected to 500 hours of salt fog treatment, in accordance with military specification MIL-PRF-24712, the coating exhibited excellent corrosion protection, with an average undercut of 0.8 mm and a maximum undercut of 4 mm.

When the sprayed thermoset coating of Formulation A was intentionally scratched with a screwdriver, the coating was easily repaired using the polymer thermal spraying (PTS) method described herein. The scratch was repaired by PTS method, which applied additional powder material followed by in-situ flowing and curing at 180° C. in less than one minute.

What is claimed is:

1. A powder coating composition comprising particles having a diameter of from about 20 μm to about 250 μm comprising: (1) a hydroxyl- and/or carboxyl-terminated polyester having a number average molecular weight of from about 1000 to about 6000 and a dynamic shear viscosity of less than 5000 cPs; (2) from about 1% to about 50% by weight of the polyester of a cross-linking agent capable of reacting with the terminal groups of the polyester and wherein the powder coating composition has a density of from about 0.95 g/cm³ to about 1.8 g/cm³.

2. The composition of claim 1 wherein the polyester is carboxyl-terminated and the cross-linking agent is a β-hydroxyl alkylamide.

3. The composition of claim 1 wherein the polyester is carboxyl-terminated and the cross-linking agent is a trisglycidylisocyanurate.

4. The composition of claim 1 wherein the polyester is hydroxyl-terminated and the cross-linking agent is a blocked polyisocyanate.

5. The composition of claim 1 wherein the polyester is hydroxyl-terminated and the cross-linking agent is a polyuretdione.

6. The composition of claim 1 wherein the composition forms a continuous film at temperatures in the range of 90° C. to 150° C. and cures at temperatures in the range of 120° C. to 220° C.

7. The composition of claim 1 further comprising additives selected from the group consisting of catalysts, fillers, fibers, pigments, flow agents, bubble-release agents, antioxidants, heat stabilizers, UV absorbers, flame-retardant agents, gloss agents, electrical conductive agents, clarifying agents, blowing agents, compatibility agents, and combinations thereof.

8. The composition of claim 7 wherein the filler is titanium dioxide, aluminum oxide, silicon dioxide, talc, alumino-silicates, phyllosilicates and combinations thereof.

9. A powder coating composition comprising particles having a diameter of from about 30 μm to about 100 μm comprising: (1) a hydroxyl- and/or carboxyl-terminated polyester having a number average molecular weight of from about 2,000 to about 6,000 and a dynamic shear viscosity of less than 3,500 cPs; (2) from about 1% to about 40% by weight of the polyester of a cross-linking agent capable of reacting with the terminal groups of the polyester and wherein the powder coating composition has a density of from about 0.95 g/cm³ to about 1.5 g/cm³.

10. The composition of claim 9 wherein the polyester is carboxyl-terminated and the cross-linking agent is a β-hydroxyl alkylamide.

11. The composition of claim 9 wherein the polyester is carboxyl-terminated and the cross-linking agent is a trisglycidylisocyanurate.

12. The composition of claim 9 wherein the polyester is hydroxyl-terminated and the cross-linking agent is a blocked polyisocyanate.

13. The composition of claim 9 wherein the polyester is hydroxyl-terminated and the cross-linking agent is a polyuretdione.

14. The composition of claim 9 wherein the composition forms a continuous film at temperatures in the range of 90° C. to 120° C. and cures at temperatures in the range of 120° C. to 180° C.

15. The composition of claim 9 further comprising additives selected from the group consisting of catalysts, fillers, fibers, pigments, flow agents, bubble-release agents, antioxidants, heat stabilizers, UV absorbers, flame-retardant agents, gloss agents, electrical conductive agents, clarifying agents, blowing agents, compatibility agents and combinations thereof.

16. The composition of claim 10 wherein the filler is titanium dioxide, aluminum oxide, silicon dioxide, talc, alumino-silicates, phyllosilicates and combinations thereof.

17. A method of imparting improved corrosion- and wear-resistance to a substrate, comprising contacting a substrate with an amount of a composition of claim 1 effective to provide improved corrosion- and wear-resistance.

18. The method of claim 17 wherein the substrate is selected from the group consisting of steel, aluminum, copper, phosphor-bronze alloys, copper-nickel-tin alloys, copper-nickel-zinc alloys, copper-nickel alloys, concrete, brick, concrete masonry unit (CMU) block, grout, plaster, gunite, tile, aggregate and combinations thereof.

19. A substrate coated with a cured powder coating composition wherein the pre-cured composition comprises particles having a diameter of from about 20 um to about 250 um comprising: (1) a hydroxyl- and/or carboxyl-terminated polyester having a number average molecular weight of from about 1,000 to about 6,000 and a dynamic hear viscosity of less than 5,000 cPs; (2) from about 1% to about 50% by weight of the polyester of a cross-linking agent capable of reacting with the terminal groups of the polyester and wherein the powder coating composition has a density of from about 0.95 g/cm³ to about 1.8 g/cm³ and wherein the coated substrate has improved corrosion- and wear-resistance compared to an uncoated substrate.

20. A method of repairing a damaged substrate coating comprising the steps of: (1) heating a gas flow stream in a thermal spray gun to a temperature of between about 100° C. to about 900° C. to produce a heated gas flow stream and projecting the heated gas flow stream toward a target damaged substrate coating through a point of convergence of a converging nozzle; injecting a powdered coating composition of claim 1 into the heated gas flow stream through at least one material injector coupled to the thermal spray gun that is operative to propel the powdered material into the heated gas flow stream such that the powdered material at least partially melts within the heated gas flow stream to produce a plurality of heated material particles; and (2) directing and propelling the heated material particles onto the damaged substrate coating whereby the damaged coating and the melted powder coating fuse together to produce a continuous coating.

21. A method of coating a substrate comprising contacting the substrate with the composition of claim 1 wherein the method is selected from the group consisting of electrostatic fluidized bed, fluidized bed, hot flocking, electrostatic spray, tribocharging processes, and a combination thereof.
